(19) United States
(12) Patent Application Publication
(10) Pub. No.: US 2016/0031107 A1
(43) Pub. Date: Feb. 4, 2016

(54) Fruit Arrangement

(71) Applicant: Edible Arrangements, LLC, Wallingford, CT (US)

(72) Inventor: Tariq Farid, Chesire, CT (US)

(73) Assignee: Edible Arrangements, LLC, Wallingford, CT (US)

(21) Appl. No.: 14/548,279

(22) Filed: Nov. 19, 2014

Related U.S. Application Data
(60) Provisional application No. 61/906,115, filed on Nov. 19, 2013.

(51) Int. Cl. B26D 3/26; B65D 85/34; B65D 43/06

(52) U.S. Cl. CPC B26D 3/26; B65D 43/06; B65D 85/34

(57) ABSTRACT

A fruit arrangement system including a cutter and a storage container.

### PRIORITY

This application claims priority to provisional filing 61/906,115 filed Nov. 19, 2013.

### FIELD OF INVENTION

The invention is directed to unique ways in preparing fruit arrangements and presenting them to consumers in a commercial environment. The inventions incorporate unique designs and features of multiple items of which each one singularly represents an innovative concept and design.

### BACKGROUND OF THE INVENTION

Selling items to the consuming public requires “catchy” items which attract the attention of the consumer. This is a common occurrence in just about every commodity sold which does not include technology. In the fruit arrangement business, creativity is necessary to attract customers and ultimate purchasers. This invention identifies several discrete components, each individually patentable on their own for the creation, display and sale of fruit arrangements.

### DRAWINGS

This disclosure includes several drawings depicting various elements.

FIG. 1 illustrates an embodiment of a cupcake press cutter;

FIG. 2 illustrates an embodiment of a cupcake press cutter;

FIG. 3 illustrates an embodiment of a cupcake press cutter;

FIG. 4 illustrates an embodiment of the side view of a cupcake press cutter;

FIG. 5 illustrates an embodiment of the side view of a cupcake press cutter;

FIG. 6 illustrates an embodiment of the side view of a cupcake press cutter;

FIG. 7 illustrates an embodiment of a cupcake press cutter;

FIG. 8 illustrates a cupcake press for operation with the cupcake press cutter for developing a cupcake design;

FIG. 9 illustrates a cupcake press for operation with the cupcake press cutter for developing a cupcake design;

FIG. 10 illustrates a cupcake press for operation with the cupcake press cutter for developing a cupcake design;

FIG. 11 illustrates a cupcake press for operation with the cupcake press cutter for developing a cupcake design;

FIG. 12 illustrates a cupcake press for operation with the cupcake press cutter for developing a cupcake design;

FIG. 13 illustrates a cupcake press for operation with the cupcake press cutter for developing a cupcake design;

FIG. 14 illustrates an embodiment of a martini cup assembly for holding a fruit arrangement;

FIG. 15 illustrates an embodiment of a martini cup assembly for holding a fruit arrangement;

FIG. 16 illustrates an embodiment of a martini cup assembly for holding a fruit arrangement;

FIG. 17 illustrates an embodiment of a martini cup assembly for holding a fruit arrangement;

FIG. 18 illustrates an embodiment of a martini cup assembly for holding a fruit arrangement;

FIG. 19 illustrates an embodiment of a martini cup assembly for holding a fruit arrangement;

FIG. 20 illustrates an embodiment of a martini cup assembly for holding a fruit arrangement;

FIG. 21 illustrates an embodiment of a martini cup assembly for holding a fruit arrangement;

FIG. 22 illustrates an embodiment of a martini cup assembly for holding a fruit arrangement;

FIG. 23 illustrates an embodiment of a martini cup assembly for holding a fruit arrangement;

FIG. 24 illustrates an embodiment of a martini cup assembly for holding a fruit arrangement;

FIG. 25 illustrates an embodiment of a martini cup assembly for holding a fruit arrangement;

FIG. 26 illustrates a second embodiment of a martini cup assembly for holding a fruit arrangement;

FIG. 27 illustrates a second embodiment of a martini cup assembly for holding a fruit arrangement;

FIG. 28 illustrates a second embodiment of a martini cup assembly for holding a fruit arrangement;

FIG. 29 illustrates an embodiment of a pine pop tray for holding cut pineapples;

FIG. 30 illustrates an embodiment of a pine pop tray for holding cut pineapples;

FIG. 31 illustrates an embodiment of a pine pop tray for holding cut pineapples;

FIG. 32 illustrates an embodiment of a pine pop tray for holding cut pineapples.

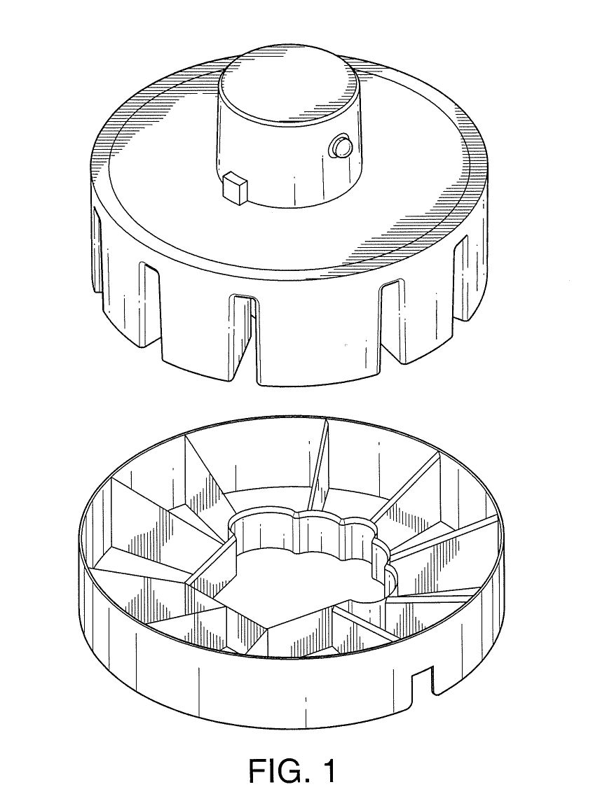

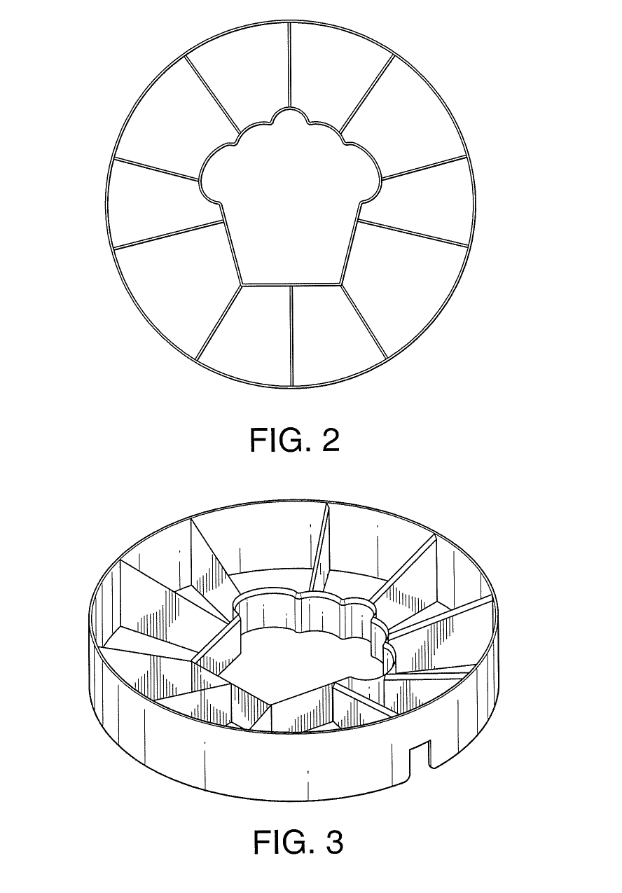

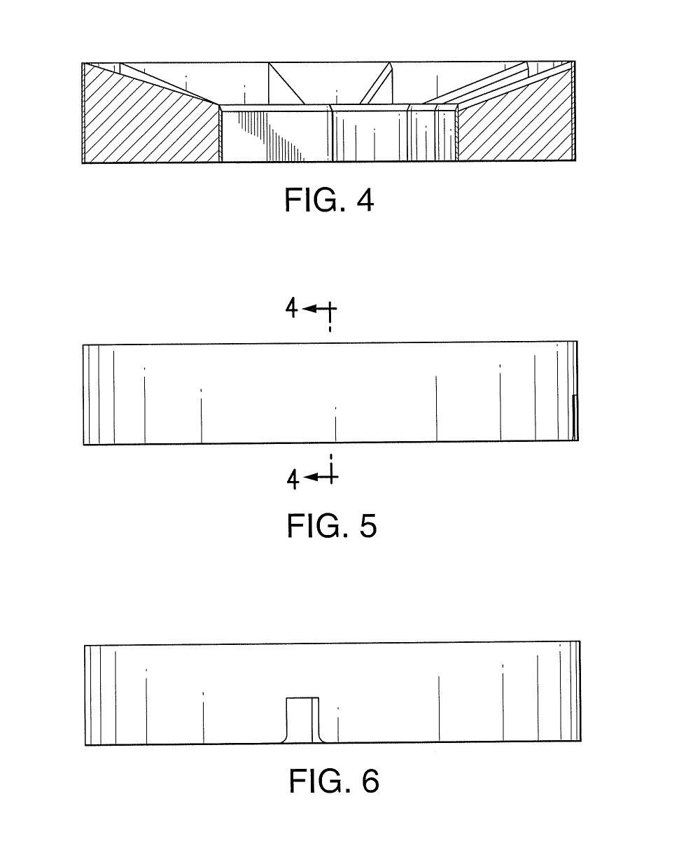

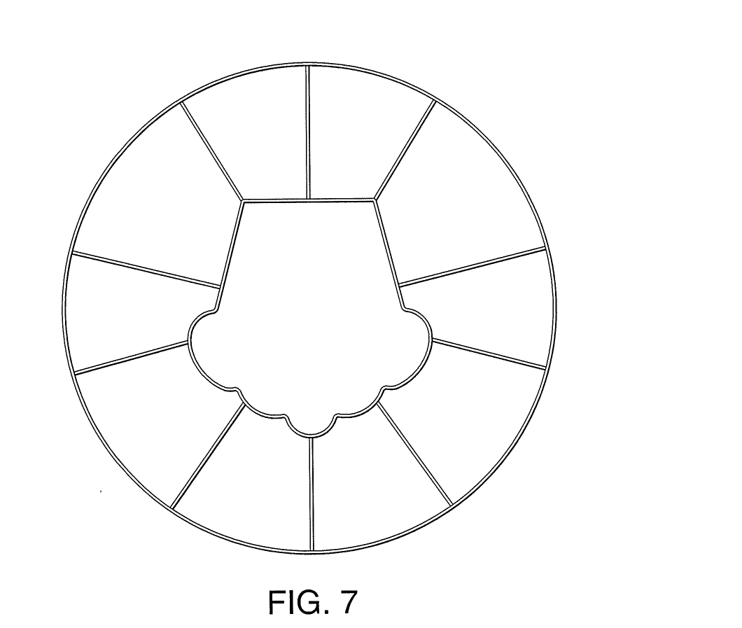

### SUMMARY

A fruit arrangement carrier comprising a central body having a conical shape resembling a martini glass. A wide base for carrying said central body. The central body having an internal lip creating an offset with the interior of the central body. A weighted cover having a downwardly extending lip for being received with said offset for securing said weighted cover with said central body.

### PREFERRED EMBODIMENT

The assignee of these inventions, Edible Arrangements, International has received several patents on the development of systems, methods, designs, relating to the processing and selling of unique fruit arrangements. Such patents include designs for the various shapes of the cut fruit, machines utilized for cutting the fruit, and individual components of the assemblies such as the foam.

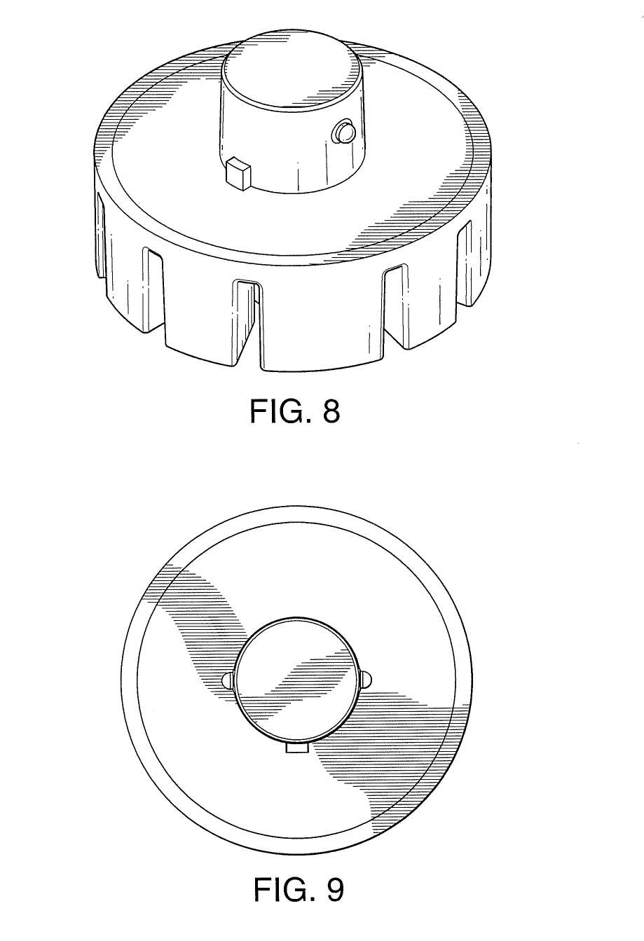

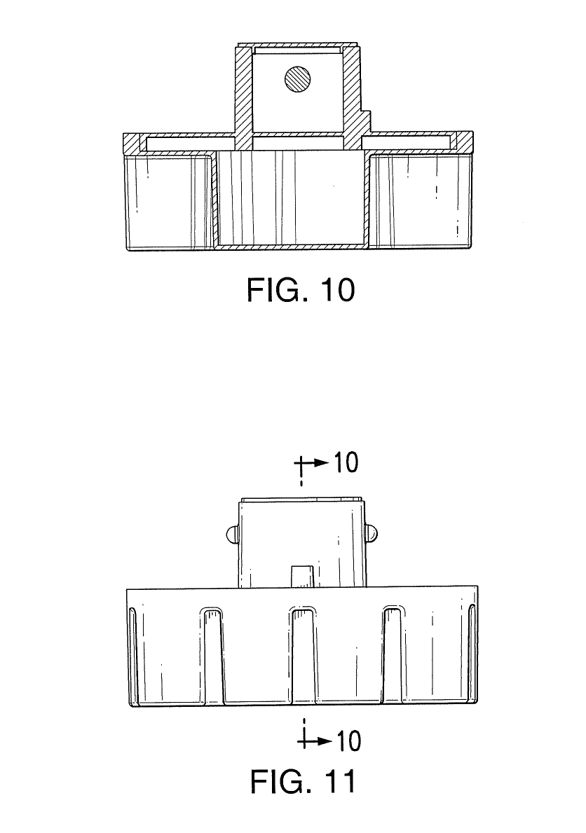

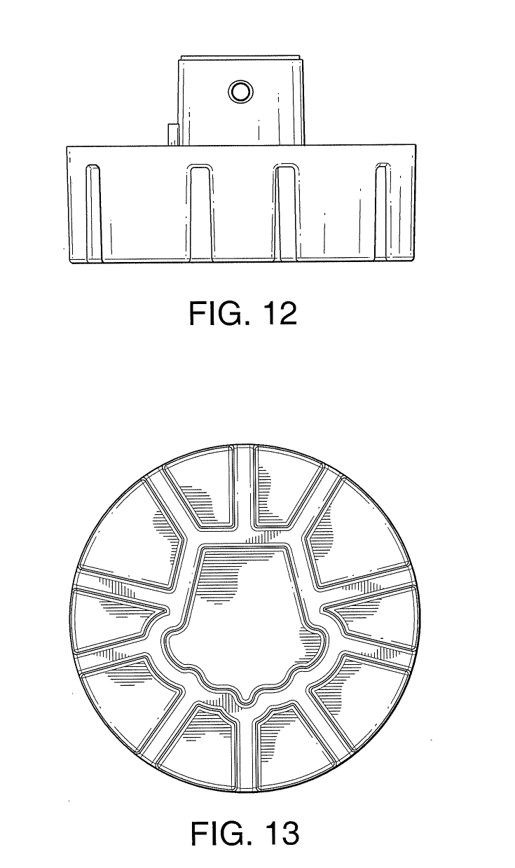

The cupcake press cutter is intended for use in the melon wedger U.S. Pat. No. 7,568,414 and its derived modifications. The cupcake cutter includes location notches, is made from food safe stainless steel and has a central cupcake design with tangential blade components. In the preferred embodiment a pineapple is utilized as the fruit of choice for the cupcake design. A related press which pushes the fruit through the blade is illustrated in FIGS. 8-13.

The press cutter has a central design supported by internally extending ribs which extend from an outer circular frame. The central design is suspended by the internally extending ribs enabling the design to be placed onto a piece of fruit, preferably a pineapple. An external notch defined with the external frame enables the cutter to be positioned in a select position enabling a corresponding press cutter to be aligned. The corresponding press cutter has a plurality of fingers extending downward from an upper body. The plurality of fingers extends downward for interfacing with corresponding orifices of the press cutter. In the preferred embodiment, a cupcake designs centrally located for passing through the central design of the cupcake press cutter.

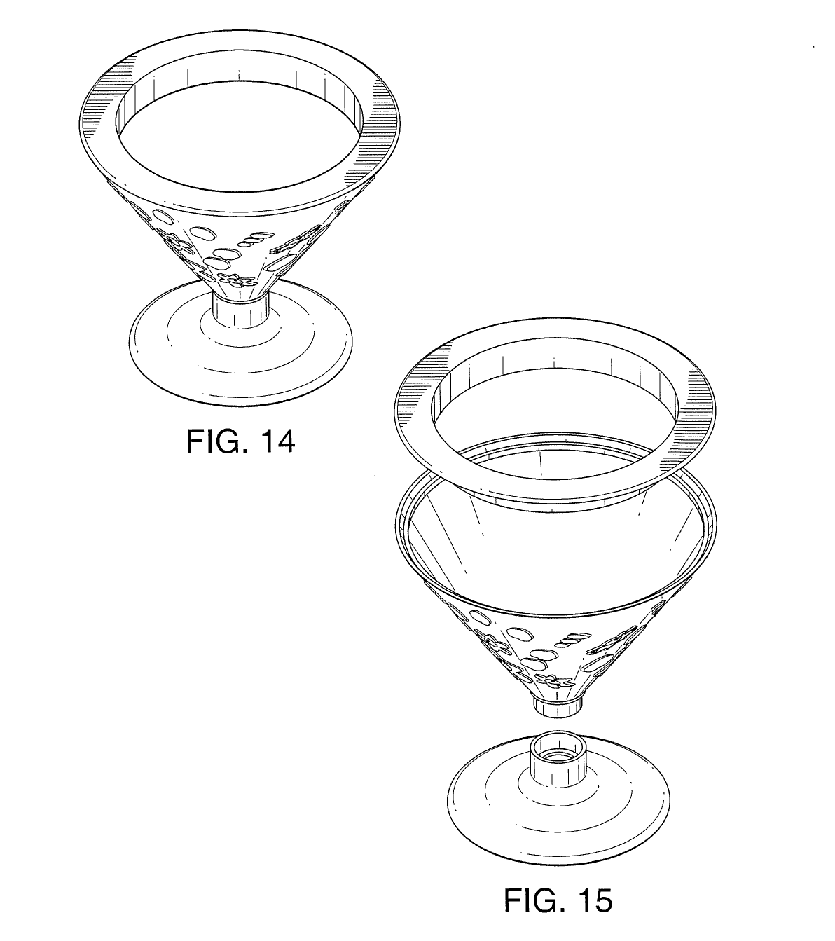

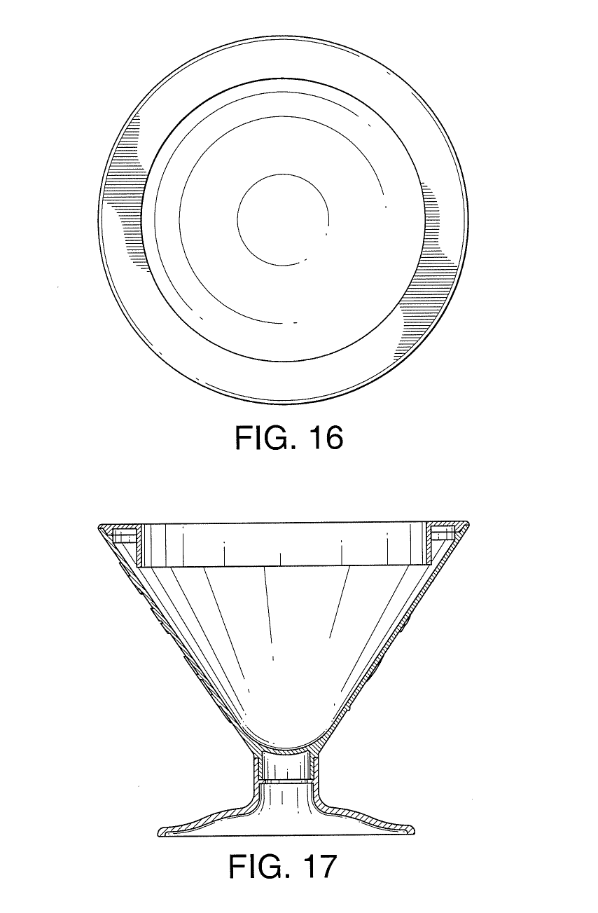

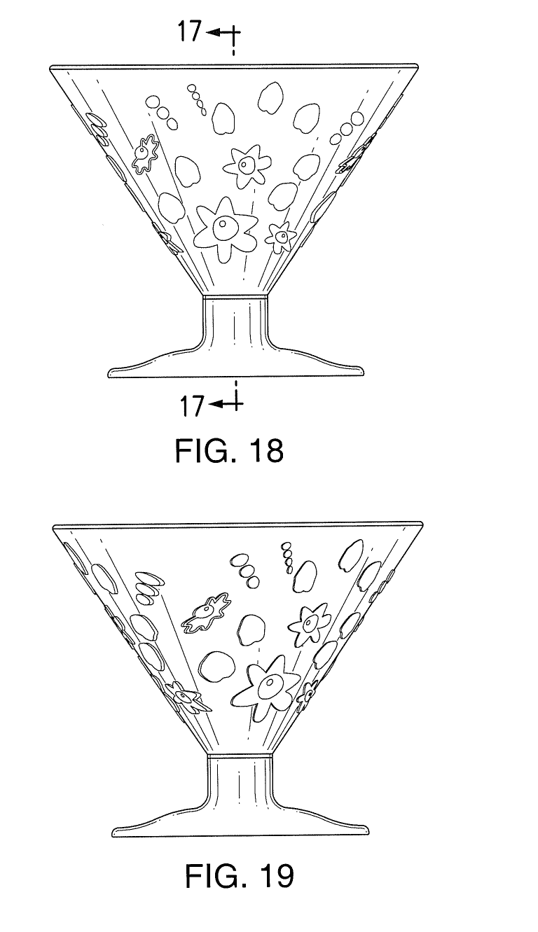

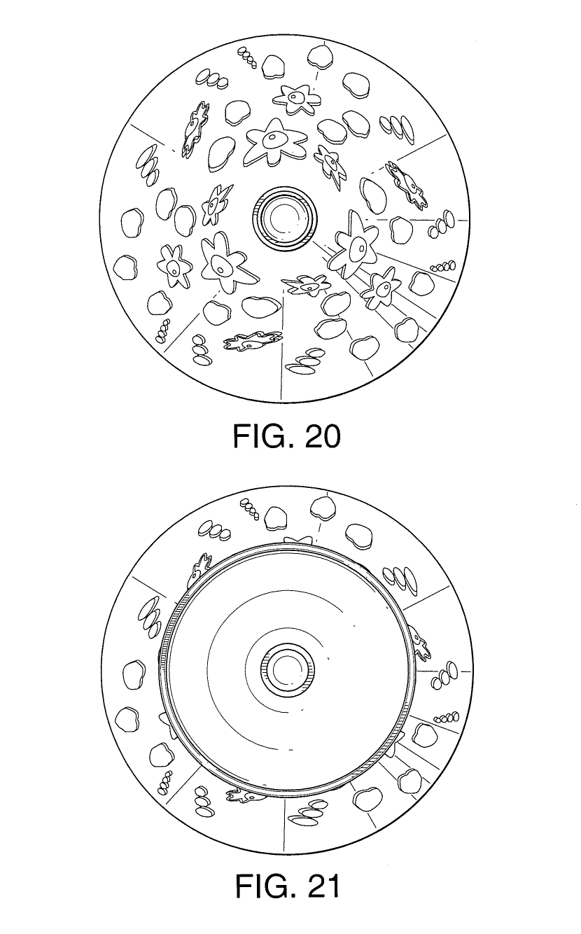

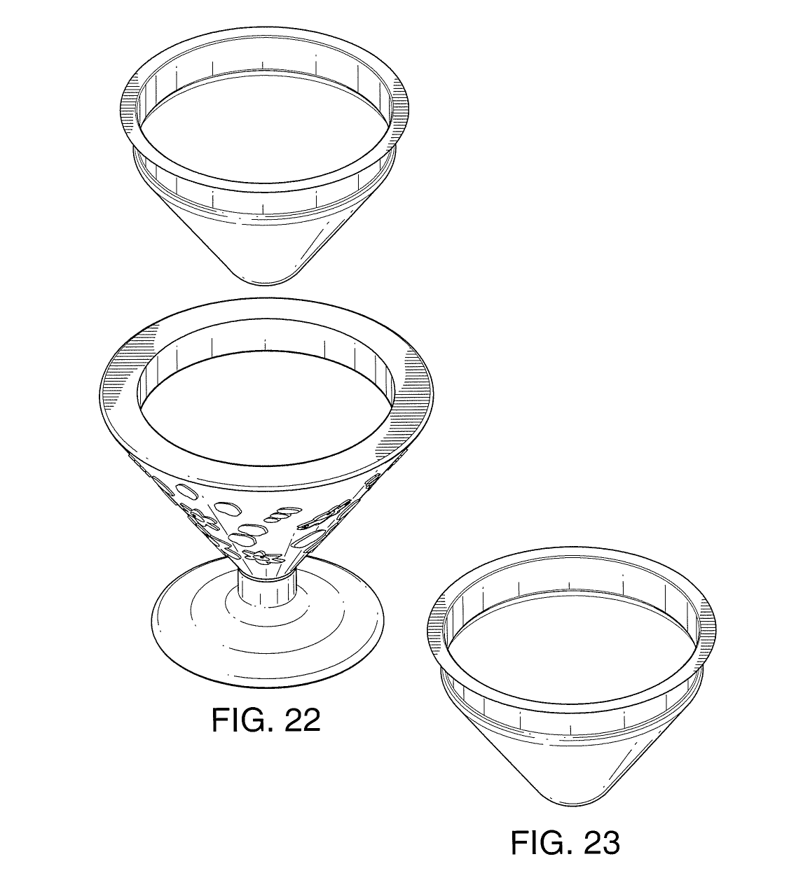

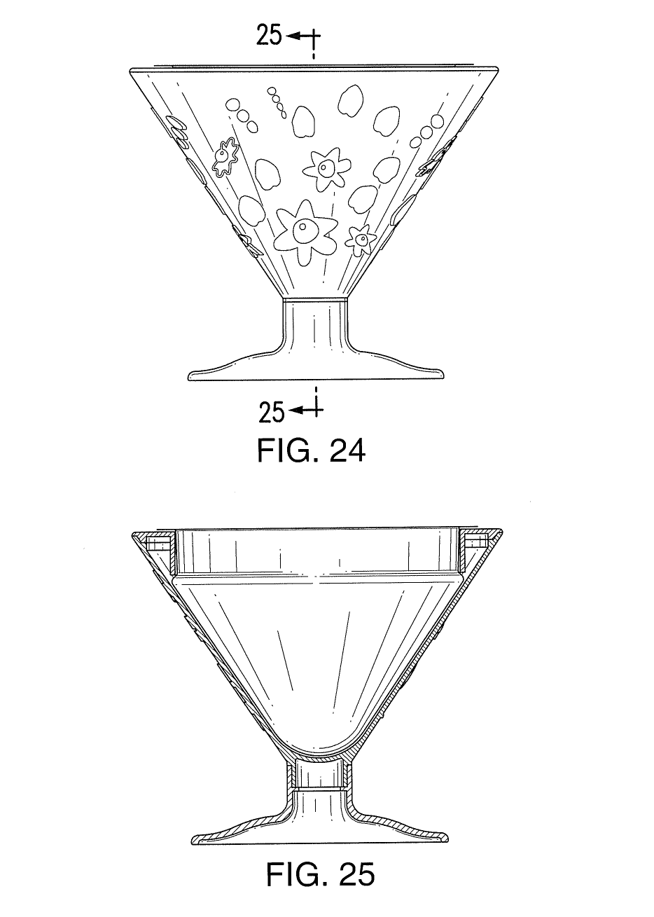

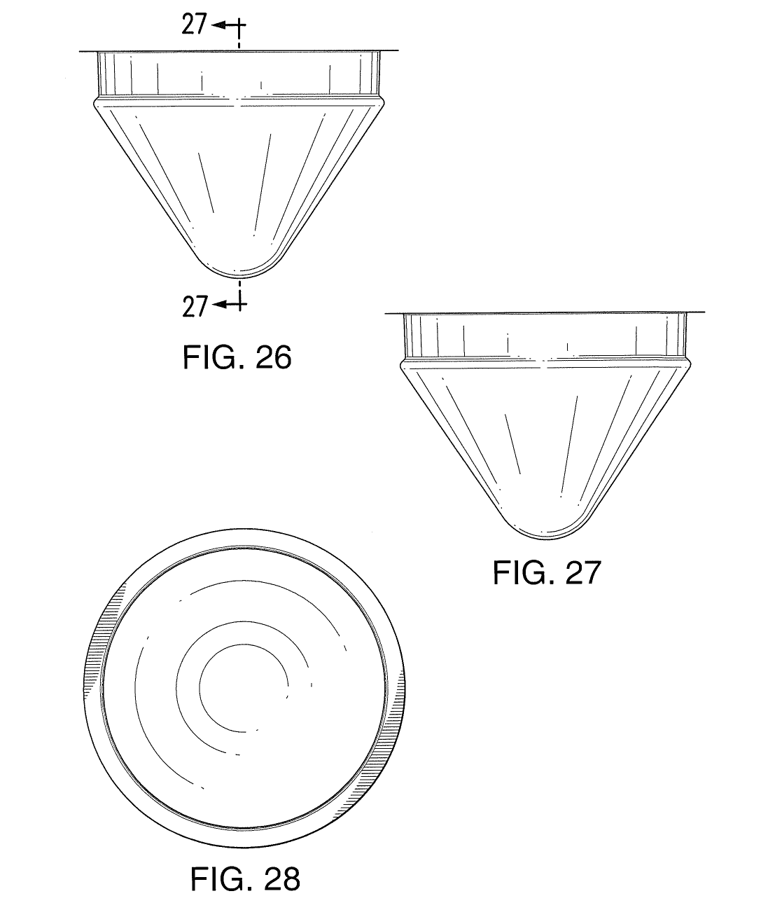

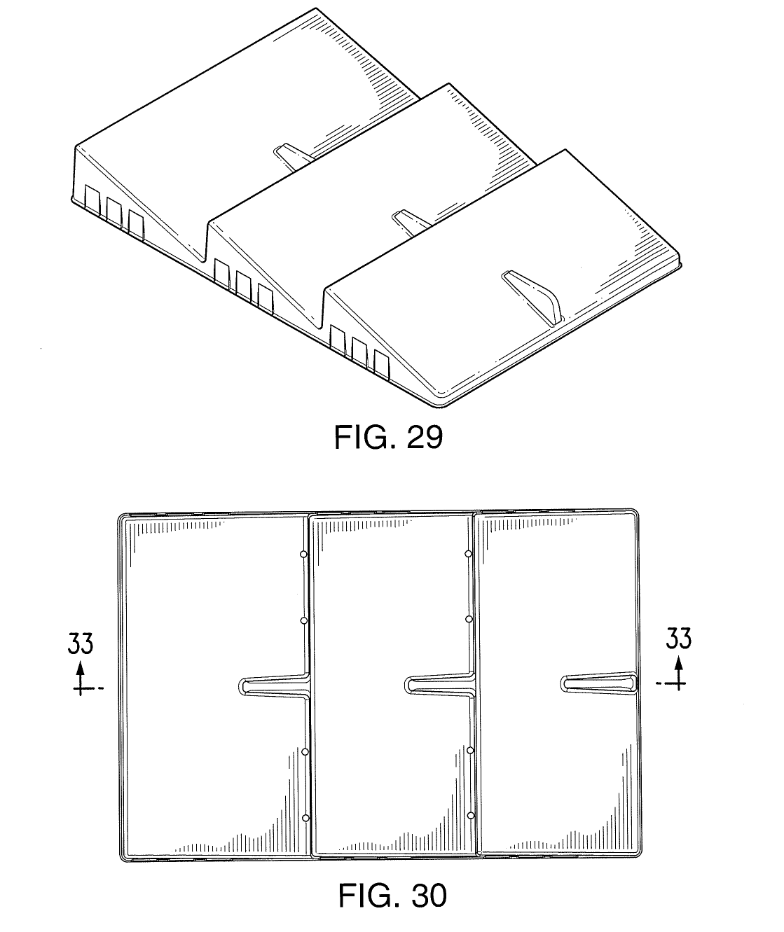

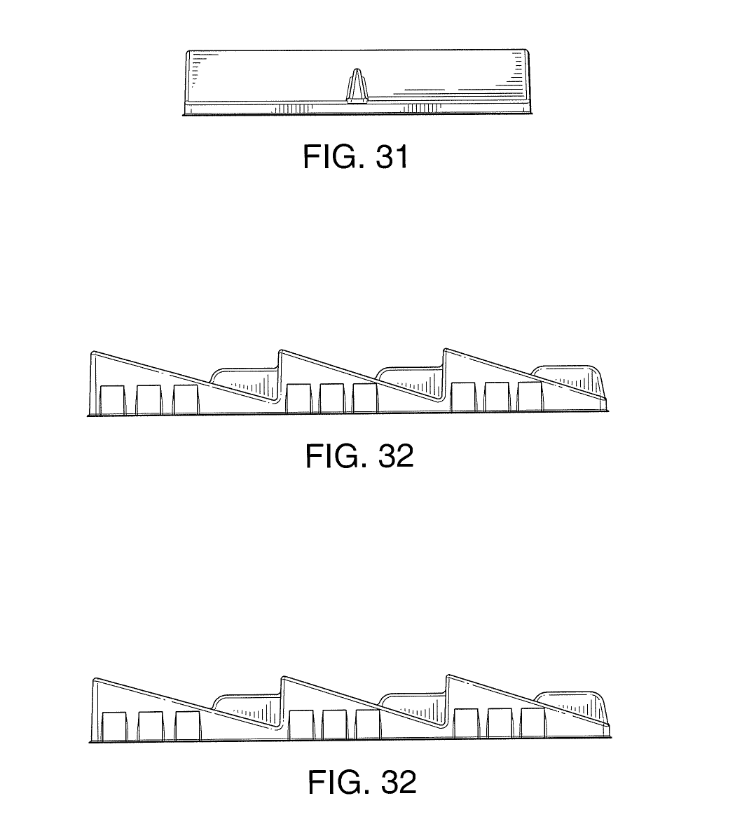

As shown in FIGS. 14-28 a martini glass fruit holder is disclosed. The martini glass includes a circular base for balance, a central conical body shaped like a martini glass. As shown in the figures, the conical body has an interior which has a sloped surface. An upper lip is formed within the interior of the conical body. The upper lip is vertically positioned establishing an offset from the interior.

A weighted cover is included for providing balance for the arrangement. The weighted cover includes an upper rim and a downwardly extending central portion. A downwardly extending flange extends downward from the outer perimeter of the upper rim. As shown in the drawings, this downwardly extending flange is received within the offset of the central body for securing the upper weighted flange with the central body. The weight of the flange is sufficient to retain the central body in an upright position when an assembly of fruit is positioned within the central body.

A wide base to balance the high center of gravity which results from assembling a fruit arrangement with in the barrel of the container. A central cup portion having a conical appearance. A lip is disposed within the interior circumference of the upper portion of the cup. The lip assists in retaining the foam which is utilized for supporting the fruit arrangement; the foam is disclosed in U.S. Pat. No. 8,474,616, within the structure. An upper cap is received within the barrel of the container and rests on the upper rim of the

Upper Lip. The upper cap also assists in retaining the foam within the structure. Various drawings are disclosed illustrating this design, Additionally, a central liner may be utilized for retaining the fruit assembly within the interior of the “glass”.

A packaging sleeve is presented which has a unite design and which may be utilized for encircling the base of the martini glass. The packaging sleeve is trifold having an upper arched shape with three container tabs located at the base of the sleeve which the bottom of the martini container will rest upon. The packaging sleeve assists in the portability of the martini glass as the glass may tip over during delivery from a franchise location to a customer. This sleeve assists in maintaining the martini glass uptight.

Additionally a pine pop tray is disclosed which is designed for holding a plurality of pineapple pieces. The pine pop tray includes a central flange divider enabling separation of the respective pineapple pieces. The pine pop tray includes a front surface and a back surface offset forming a storage chamber for receiving a pineapple piece. A plurality of holes is positioned within the base of the storage chambers enabling any fluids to flow downward to a lower located storage chamber. As shown in the drawings, one embodiment includes three distance levels of adjacent storage chambers.

A pineapple pop tray is also disclosed. This tray may be used for onsite presentation of various fruit pieces singularly displayed on skewers. Once such item is the popular cupcake design which is currently the subject of several co-pending patent applications, The pop tray includes individual compartments for receiving a skewered fruit which includes a central divider for separating the fruit along the length of the fruit. Accordingly the divider is centrally located. The pop tray may be nested with additional trays with the lower central divider of a particular pop tray facilitating in maintaining the separation of the respective displayed fruit carried by a separate pop tray. Each respective compartment includes drain holes for facilitating in the operation of the tray.

We claim:

1. A cutting system for cutting a fruit piece. comprising:
a cutter having an exterior frame defining a central interior;
a plurality of internally extending ribs;
a central design carried by said internally extending ribs; and
a cutting press having a plurality of downwardly extending fingers for matingly engaging said central design.

2. A fruit arrangement carrier comprising;
a central body having a conical shape resembling a martini glass;
a wide base for carrying said central body;
said central body having an internal lip creating an offset with the interior of said central body;
a weighted cover having a downwardly extending lip for being received with said offset for securing said weighted cover with said central body.
